(19) United States
(12) Patent Application Publication
(10) Pub. No.: US 2014/0313308 A1
(43) Pub. Date: Oct. 23, 2014

(54) APPARATUS AND METHOD FOR TRACKING GAZE BASED ON CAMERA ARRAY

(71) Applicant: SAMSUNG ELECTRONICS CO., LTD., Suwon-si (KR)

(72) Inventors: Xiying WANG, Beijing (CN); Ji Yeun KIM, Seoul (KR); Shuzheng GAO, Beijing (CN)

(73) Assignee: SAMSUNG ELECTRONICS CO., LTD., Suwon-si (KR)

(21) Appl. No.: 14/254,008

(22) Filed: Apr. 16, 2014

(30) Foreign Application Priority Data
Apr. 19, 2013 (CN) 201310138541.6
Feb. 11, 2014 (KR) 10-2014-0015528

(51) Int. Cl. G06K 9/00

(52) U.S. Cl. CPC G06K 9/00604; G06K 9/00248
USPC 348/78

(57) ABSTRACT

An apparatus and method for tracking a gaze based on a camera array are provided. The apparatus may include a camera array including a plurality of cameras, and a plurality of light sources for the plurality of cameras, a light source controller to control the plurality of light sources so that the plurality of cameras capture a bright pupil image and a dark pupil image of a user, a detector to detect a position of a pupil center of the user, and a position of a glint caused by reflection of the plurality of light sources from the captured bright pupil image and the captured dark pupil image, and an estimator to estimate an interest position of eyes of the user by tracking a gaze direction of the eyes, based on the detected position of the pupil center and the detected position of the glint.

### CROSS-REFERENCE TO RELATED APPLICATIONS

This application claims the priority benefit of Chinese Patent Application No. 201310138541.6, filed on Apr. 19, 2013, in the State Intellectual Property Office of China, and Korean Patent Application No. 10-2014-0015528, filed on Feb. 11, 2014, in the Korean Intellectual Property Office, the disclosures of which are incorporated herein by reference.

### BACKGROUND

1. Field

Example embodiments of the following description relate to an apparatus and method for tracking a gaze based on a camera array.

2. Description of the Related Art

A gaze indicates a direction in which a human eye points. A gaze tracking technology refers to a technology of tracking an interest point on a screen of a display at which a user gazes, and may have great potential for application in a human-computer interaction (HCl) field. A gaze may be used as a computer input device more efficiently than a typical input device, for example, a mouse, pen, a keyboard, and the like, and may be conveniently used for physically handicapped persons.

However, in reality, it is difficult to accurately estimate a direction of a gaze. Additionally, it may be even more difficult to accurately estimate a gaze of each of a plurality of users, due to a change in light, or a large head turn angle.

### SUMMARY

The foregoing and/or other aspects are achieved by providing an apparatus for tracking a gaze, the apparatus including a camera array including a plurality of cameras, and a plurality of light sources for the plurality of cameras, a light source controller to control the plurality of light sources so that the plurality of cameras capture a bright pupil image and a dark pupil image of a user, a detector to detect a position of a pupil center of the user, and a position of a glint caused by reflection of the plurality of light sources from the captured bright pupil image and the captured dark pupil image, and an estimator to estimate an interest position of eyes of the user by tracking a gaze direction of the eyes, based on the detected position of the pupil center and the detected position of the glint.

A camera among the plurality of cameras in the camera array may capture a bright pupil image of the user using light emitted from a coaxial light source corresponding to the camera, and may capture a dark pupil image of the user using light emitted from an off-axis light source that does not correspond to the camera.

The light source controller may allow the plurality of light sources to sequentially emit light.

The detector may detect the position of the pupil center from the bright pupil image, and may detect the position of the glint from the dark pupil image.

The detector may detect the position of the pupil center, based on grayscale information of an eye area in the bright pupil image.

The detector may divide a pupil area in the bright pupil image based on the grayscale information, may perform ellipse fitting on an outline of the divided pupil area, may determine a center of a fitted ellipse as the pupil center, and may detect the position of the pupil center.

The detector may detect the position of the glint from the dark pupil image, based on a corneal glint.

The detector may search for a circular glint closest to the position of the pupil center from among glints that are adjacent to each other and that are similar in size, in the dark pupil image, may determine the found glint as the corneal glint, and may detect the position of the glint.

The estimator may calculate a three-dimensional (3D) spatial position of a corneal center of each of the eyes, and a 3D spatial position of the pupil center, based on the detected position of the pupil center and the detected position of the glint, and may estimate the interest position based on a calculation result.

The estimator may calculate 3D coordinates of a corneal center of each of the eyes, and 3D coordinates of the pupil center, using a binocular gaze estimation model that is based on the detected position of the pupil center and the detected position of the glint, may acquire the gaze direction based on a calculation result, and may estimate the interest position.

The estimator may acquire a gaze direction of each of the eyes in an optical axis of a gaze connecting the pupil center and the corneal center, based on the calculation result, and may estimate the interest position.

The apparatus may further include a corrector to correct the estimated interest position, using a plurality of target points that are estimated in advance in a surface at which the user gazes.

The detector may determine a position of each of the plurality of target points. The corrector may calculate an error between an actual position of each of the plurality of target points and the determined position, and may correct the estimated interest position, using the error and a weight that is based on a distance between the interest position and the determined position.

The foregoing and/or other aspects are achieved by providing a method for tracking a gaze, the method including capturing a bright pupil image and a dark pupil image of a user, using a camera array, the camera array including a plurality of cameras, and a plurality of light sources corresponding to the plurality of cameras, detecting a position of a pupil center of the user, and a position of a glint caused by reflection of the plurality of light sources from the captured bright pupil image and the captured dark pupil image, and calculating a 3D spatial position of a corneal center of each of eyes of the user, and a 3D spatial position of the pupil center, based on the detected position of the pupil center and the detected position of the glint, and estimating an interest position of the eyes.

The capturing may include capturing, by a camera among the plurality of cameras in the camera array, a bright pupil image of the user using light emitted from a coaxial light source corresponding to the camera, and capturing a dark pupil image of the user using light emitted from an off-axis light source that does not correspond to the camera.

The detecting may include dividing a pupil area in the bright pupil image, based on grayscale information of an eye area in the bright pupil image, performing ellipse fitting on an outline of the divided pupil area, and determining a center of a fitted ellipse as the pupil center, and detecting the position of the pupil center.

The detecting may include searching for a circular glint closest to the position of the pupil center from among glints that are adjacent to each other and that are similar in size, in the dark pupil image, and determining the found glint as a corneal glint, and detecting the position of the glint.

The estimating may include calculating 3D coordinates of a corneal center of each of the eyes, and 3D coordinates of the pupil center, using a binocular gaze estimation model that is based on the detected position of the pupil center and the detected position of the glint, and acquiring a gaze direction of the eyes based on a calculation result, and estimating the interest position.

The method may further include determining a position of each of a plurality of target points that are estimated in advance in a surface at which the user gazes, calculating an error between an actual position of each of the plurality of target points and the determined position, calculating a weight based on a distance between the interest position and the determined position, and correcting the estimated interest position, using an error correction model that is based on the error and the weight.

The foregoing and/or other aspects are achieved by providing a display including a gaze tracking apparatus. The display includes a camera array comprising a plurality of cameras, and a plurality of light sources, a light source controller to control the plurality of light sources so that the plurality of cameras capture a bright pupil image and a dark pupil image of a user, a detector to detect a position of a pupil center of the user from the captured bright pupil image and to detect a position of a glint caused by reflection of the plurality of light sources from the captured dark pupil image, and an estimator to estimate an interest position of eyes of the user, on the display, by tracking a gaze direction of the eyes on the display, based on the detected position of the pupil center and the detected position of the glint.

In the display, the estimator calculates a three-dimensional (3D) spatial position of a corneal center of each of the eyes, and a 3D spatial position of the pupil center, based on the detected position of the pupil center and the detected position of the glint, respectively, and estimates the interest position based on a calculation result.

Additional aspects of example embodiments will be set forth in part in the description which follows and, in part, will be apparent from the description, or may be learned by practice of the disclosure.

### BRIEF DESCRIPTION OF THE DRAWINGS

These and/or other aspects will become apparent and more readily appreciated from the following description of example embodiments, taken in conjunction with the accompanying drawings of which:

FIG. 1 illustrates a diagram of an apparatus for tracking a gaze according to example embodiments;

FIG. 2 illustrates a block diagram of an apparatus for tracking a gaze according to example embodiments;

FIG. 3 illustrates a diagram of a camera array in an apparatus for tracking a gaze according to example embodiments;

FIG. 4 illustrates a diagram of a light source and a camera in the camera array of FIG. 3;

FIG. 5 illustrates a graph of a scheme of synchronizing an image collection speed of a camera with light emitted from a light source according to example embodiments;

FIG. 6 illustrates a flowchart of a method of tracking a gaze according to example embodiments;

FIG. 7 illustrates a flowchart of an example of a scheme of detecting a position of a pupil center from a bright pupil image according to example embodiments;

FIG. 8 illustrates a flowchart of another example of a scheme of detecting a position of a pupil center from a bright pupil image according to example embodiments;

FIG. 9 illustrates a flowchart of a scheme of detecting a position of a glint from a dark pupil image according to example embodiments;

FIG. 10 illustrates a diagram of an example of detecting a position of a glint from a dark pupil image according to example embodiments;

FIG. 11 illustrates a flowchart of a scheme of estimating an interest position of eyes according to example embodiments;

FIG. 12 illustrates a diagram illustrating a binocular gaze estimation model according to example embodiments; and

FIG. 13 illustrates a flowchart of a scheme of correcting an estimated interest position according to example embodiments.

### DETAILED DESCRIPTION

Reference will now be made in detail to embodiments, examples of which are illustrated in the accompanying drawings, wherein like reference numerals refer to like elements throughout. Example embodiments are described below to explain the present disclosure by referring to the figures.

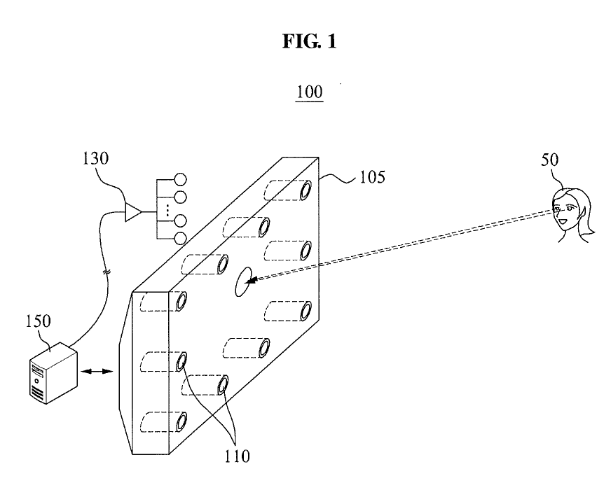

FIG. 1 illustrates a diagram of an apparatus 100 for tracking a gaze according to example embodiments.

The apparatus 100 for tracking a gaze, hereinafter referred to as a gaze tracking apparatus, may include a display 105, as shown in FIG. 1, or the display 105 may include the gaze tracking apparatus 100.

The display 105 may include a camera array 110. The camera array 110 may include a plurality of cameras, and a plurality of light sources corresponding to the plurality of cameras.

The gaze tracking apparatus 100 may include a light source controller 130, and a processor 150. The light source controller 130 and the processor 150 may be separated from the display 105, as shown in FIG. 1, or may be formed integrally with the display 105.

The plurality of cameras in the camera array 110 may be installed at an upper side, a lower side, a left side, a right side, and the like on a screen of the display 105 at which a user 50 gazes.

The plurality of light sources may each include, for example, infrared (IR) light emitting diodes (LEDs), however, there is no limitation thereto. Accordingly, various light sources may be used.

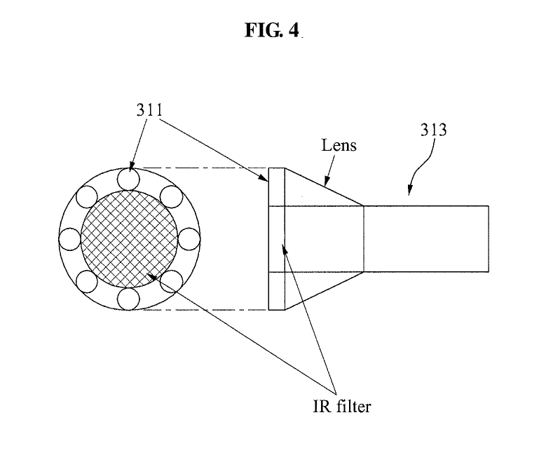

The plurality of light sources may be installed as coaxial light sources corresponding to the plurality of cameras, or as off-axis light sources. For example, a single camera may correspond to a single light source, and LEDs of the light source may enclose the camera, as shown in FIG. 4. In this example, a center of the light source may be aligned with a center of the camera and accordingly, a coaxial light source may be implemented. Any light source that does not correspond to a single camera may act as an off-axis light source.

For example, a single camera may capture a bright pupil image of a user using light emitted from a single coaxial light source corresponding to the camera. In this example, the other cameras may be allowed to capture a dark pupil image of the user using light emitted from a plurality of off-axis light sources that do not correspond to the camera.

The light source controller 130 may control the light sources in the camera array 110 to sequentially emit light. The light source controller 130 may be implemented as a multi-way switch to power on and off the plurality of light sources, as shown in FIG. 1, and the processor 150 may be implemented to perform a function of the light source controller 130.

The processor 150 may track a gaze direction of eyes of the user 50, based on a pupil image of a user captured by the camera array 110, and may estimate an interest position on the display 105 upon which the user gazes. The processor 150 may be implemented, for example, by a micro-controller, a central processing unit (CPU), a digital signal processor (DSP), an ARM processor, and the like.

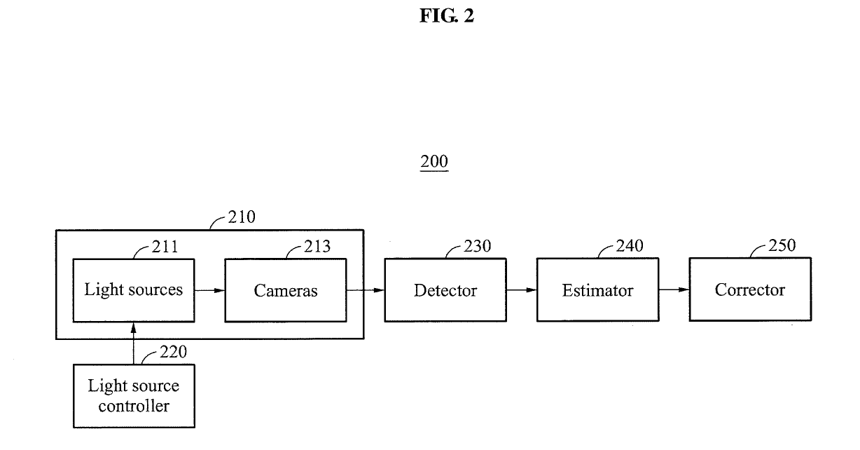

FIG. 2 illustrates a block diagram of a gaze tracking apparatus 200 according to example embodiments.

Referring to FIG. 2, the gaze tracking apparatus 200 may include, for example, a camera array 210, a light source controller 220, a detector 230, and an estimator 240. Additionally, the gaze tracking apparatus 200 may further include a corrector 250.

The camera array 210 may include a plurality of cameras 213, and a plurality of light sources 211 for the plurality of cameras 213. The camera array 210 may be used to acquire an image representing an eye or a pupil of a user who gazes at a display.

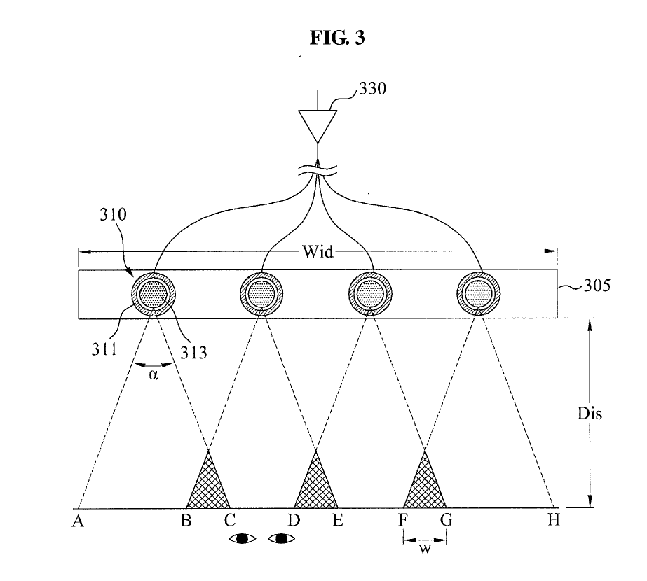

A structure of the camera array 210, and the light sources 211 and cameras 213 in the camera array 210 will be further described later below with reference to FIGS. 3 and 4.

The light source controller 220 may control the plurality of light sources 211 in the camera array 210. The light source controller 220 may control the plurality of light sources 211 to sequentially emit light, so that the plurality of cameras 213 may capture a bright pupil image and a dark pupil image of a user.

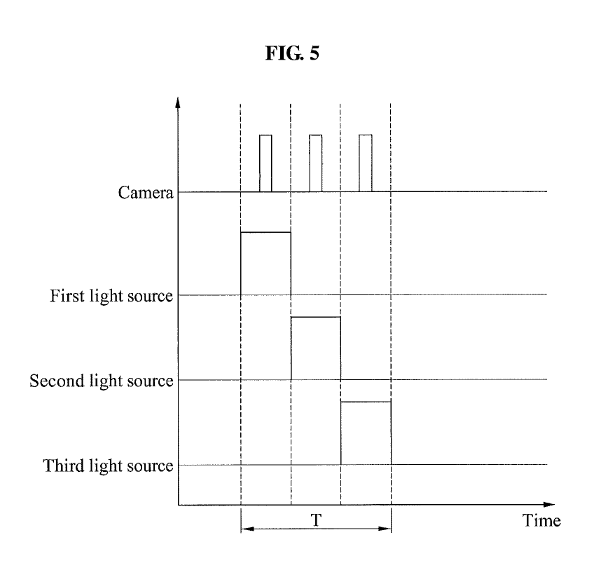

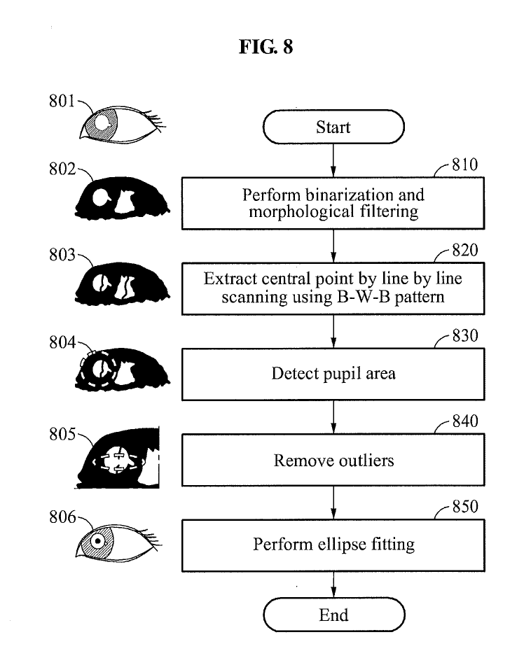

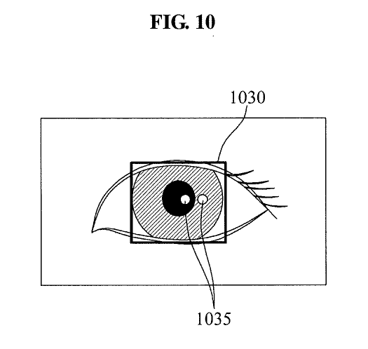

A scheme by which the light source controller 220 controls the plurality of light sources 211 will be described with reference to FIG. 5. An example of the bright pupil image, and an example of the dark pupil image are shown in FIGS. 8 and 10, respectively.

A bright pupil image may be captured using light emitted from a single coaxial light source corresponding to a camera. The bright pupil image may be used to detect a position of a pupil center.

A dark pupil image may be captured using light emitted from a plurality of off-axis light sources that do not correspond to a single camera, by the other cameras. The dark pupil image may be used to detect a position of a glint appearing on a cornea by reflection of light sources.

The detector 230 may detect features of user's eyes from pupil images acquired by the plurality of cameras 213. The features may include, for example, a position of a pupil center, a position of a glint caused by reflection of light sources, and the like.

The detector 230 may detect a position of a pupil center of a user from the bright pupil image captured by the plurality of cameras 213, and may detect a position of a glint from the dark pupil image captured by the plurality of cameras 213.

The detector 230 may detect the position of the pupil center, based on grayscale information included in the bright pupil image. The detector 230 may detect the position of the glint from the dark pupil image, based on a corneal glint.

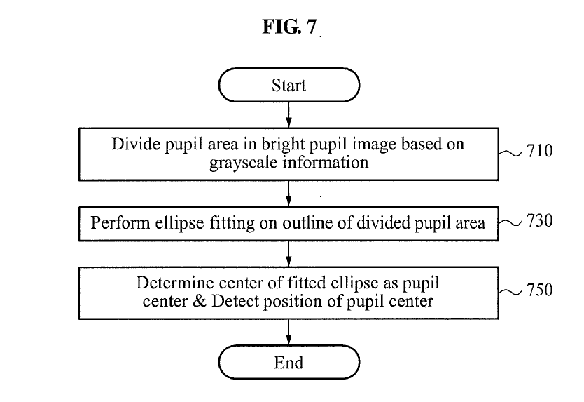

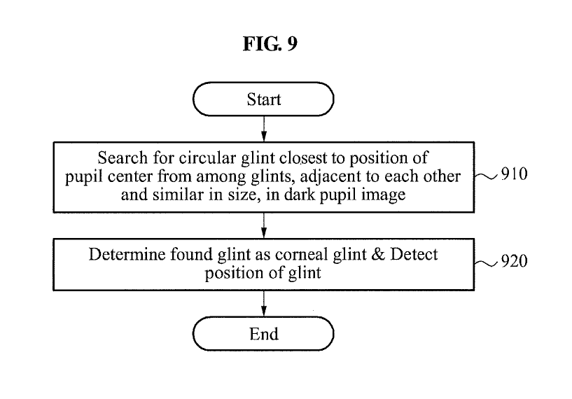

A scheme by which the detector 230 detects the position of the pupil center from the bright pupil image will be further described with reference to FIGS. 7 and 8. Additionally, a scheme by which the detector 230 detects the position of the glint from the dark pupil image will be further described with reference to FIGS. 9 and 10.

The estimator 240 may track a gaze direction of the eyes, based on the position of the pupil center and the position of the glint that are detected by the detector 230, and may estimate an interest position of the eyes. The interest position may be referred to as a “point of gaze.”

The estimator 240 may calculate a three-dimensional (3D) spatial position of a corneal center of each of the eyes, and a 3D spatial position of the pupil center, based on the position of the pupil center and the position of the glint, respectively, that are detected by the detector 230, and may estimate an interest position of the eyes based on a calculation result.

Additionally, the estimator 240 may calculate 3D coordinates of the corneal center, and 3D coordinates of the pupil center, using a binocular gaze estimation model that is based on the position of the pupil center and the position of the glint that are detected by the detector 230. The estimator 240 may track a gaze direction of the eyes based on the calculated 3D coordinates, and may thereby estimate an interest position of the eyes.

In the binocular gaze estimation model, optical axes of gazes of both eyes may be focused to a single point, for example, an interest position of the eyes, and accordingly the estimator 240 may simultaneously estimate gaze directions of the eyes. For example, the estimator 240 may compute 3D coordinates of a pupil center of each of the eyes, and 3D coordinates of a corneal center of each of the eyes, may acquire a gaze direction of a left eye and a gaze direction of a right eye, and may determine a gaze focal point of the eyes as an interest position.

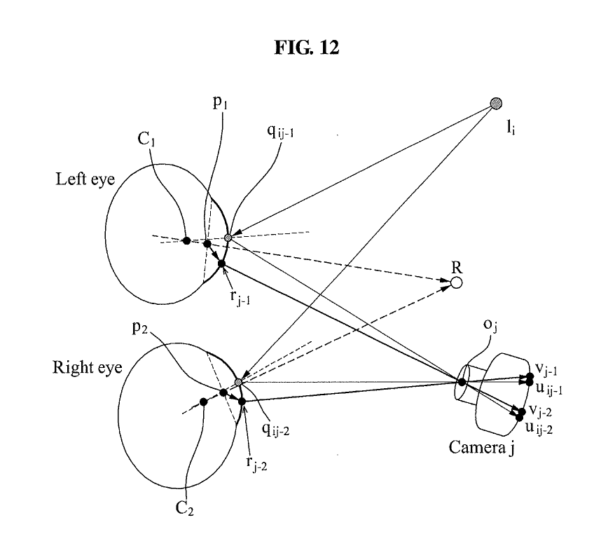

A scheme of calculating 3D coordinates of a corneal center and 3D coordinates of a pupil center using the binocular gaze estimation model will be further described with reference to FIG. 12. The binocular gaze estimation model may be called a “binocular gaze ray tracing model.”

The estimator 240 may acquire a gaze direction in an optical axis of a gaze connecting the pupil center to the corneal center, for each of a left eye and a right eye, based on the calculated 3D coordinates, and may estimate an interest position of the left eye and right eye.

The corrector 250 may correct the interest position estimated by the estimator 240, based on a plurality of target points that are estimated in advance on a screen of a display at which a user gazes.

When the interest position is estimated by the estimator 240, the corrector 250 may determine the interest position, using the plurality of target points, and may correct the interest position. Due to an error in an angle between an optical axis of a gaze and an actual axis of a gaze, correcting of the estimated interest position may be required. The optical axis of the gaze may refer to a line connecting a pupil center and a corneal center, and the actual axis of the gaze may refer to a line connecting the pupil center and a retinal center pit.

The gaze tracking apparatus 200 may determine a position of each of a plurality of target points that are estimated in advance on a screen of a display at which a user gazes, may correct a gaze direction, and may accurately determine an interest position of the eyes. A scheme by which the gaze tracking apparatus 200 corrects an estimated interest position is described below.

For example, “M” target points may be sequentially displayed on a screen, so that the “M” target points may be located farther apart from each other at an edge of the screen. “M” may be greater than “2.” In this example, when a user gazes at each of the “M” target points for a predetermined period of time, for example, 2 minutes (m), the gaze tracking apparatus 200 may collect image data indicating that the user gazes at a current target point.

The gaze tracking apparatus 200 may calculate an error between an estimation result obtained by the estimator 240 and an actual interest point, and may form an error correction model based on a position of a current interest point. The corrector 250 may correct the estimation result, using the error correction model.

For example, the gaze tracking apparatus 200 may correct an interest position of eyes, using five target points. In this example, the number of target points need not be limited, however, at least two target points may be used.

The gaze tracking apparatus 200 may determine a position of each of target points that are estimated in advance by the estimator 240, and may calculate an error between the determined position and an actual position of each of the target points. The error may be calculated by the corrector 250.

The corrector 250 may calculate a weight based on a distance between the interest position estimated by the estimator 240 and the determined position. The corrector 250 may correct the interest position estimated by the estimator 240, using an error correction model that is based on the error and the weight. The error correction model may be expressed by Equation 12 that will be described.

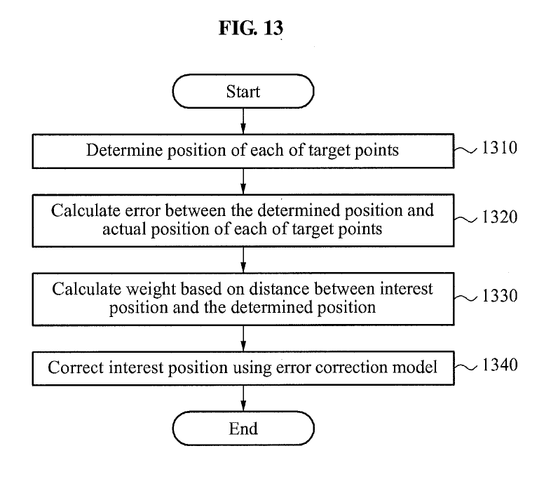

A scheme by which the corrector 250 corrects the interest position estimated by the estimator 240 will be further described with reference to FIG. 13.

FIG. 3 illustrates a diagram of a camera array in a gaze tracking apparatus according to example embodiments.

Referring to FIG. 3, a camera array 310 may be included in a display 305.

The camera array 310 may include cameras 313, and light sources 311 corresponding to the cameras 313.

Due to a requirement for a high resolution of an eye image, each of the cameras 313 in the camera array 310 may have, for example, a long focal length and a narrow viewing angle. For example, each of the cameras 313 may include a 50 mm lens with a horizontal view angle of 10°. Additionally, a viewing width of 35 centimeters (cm) in a distance of 2 meters (m) may be obtained by “AC=BE=DG=FH.”

Both eyes of a user may need to be captured in a single image and accordingly, an overlapping area between two adjacent cameras, for example, areas BC, DE, and FG, may be generated. The overlapping area may be set by a distance between a left eye and a right eye, for example, about 15 cm.

The number of the cameras 313 in the camera array 310 may be determined based on parameters, for example, a width Wid of a large display, a width of an expected free movement range, a viewing distance Dis, a viewing angle α of each of the cameras 313, an overlapped range w between two adjacent cameras, and the like.

For example, when the number of the light sources 311 in the camera array 310 is set to “N,” the number of the cameras 313 may also be set to “N.” In this example, the light source controller 330 may divide a single period T into “N” time slots, and may assign each of the “N” time slots to each of the light sources 311. A camera may capture a bright pupil image in a single time slot assigned to the camera, and the other cameras may capture a dark pupil image.

An image collection speed of each of the cameras 313 may be matched to a frequency of light emitted from each of the light sources 311. A scheme of synchronizing an image collection speed of a camera with light emitted from a light source will be described with reference to FIG. 5.

FIG. 4 illustrates a diagram of the light source 311 and the camera 313 of FIG. 3.

FIG. 4 illustrates one of the cameras 313, and one of the light sources 311 in the camera array 310.

As described above, a single camera 313 may include a single light source 311 corresponding to the single camera 313. A corresponding relationship between the light source 311 and the camera 313 may indicate that the camera 313 and the light source 311 are shaped in concentric circles. For example, the light source 311 may be installed as a coaxial light source about the camera 313.

One of the cameras 313 may include, for example, a charge coupled device (CCD), and an IR filter may be attached in front of the camera 313.

The single light source 311 may include, for example, a plurality of IR LEDs. The plurality of IR LEDs may enclose a corresponding camera 313, and may be evenly arranged to form concentric circles with the camera 313.

FIG. 5 illustrates a graph of a scheme of synchronizing an image collection speed of a camera with light emitted from a light source.

A gaze tracking apparatus according to example embodiments may control light emitting of a plurality of light sources, using a multi-way switch, and may enable a plurality of cameras to capture a bright pupil image and a dark pupil image. The multi-way switch may be switched on and off by time division.

FIG. 5 illustrates a camera, and three light sources, for example, a first light source, a second light source, and a third light source.

A single period T may be divided into three time slots, and each of the three time slots may be sequentially assigned to each of the three light sources. A multi-way switch may enable a corresponding light source to emit light sequentially for each of the three time slots. In a predetermined time slot, a single light source may emit light.

For example, a camera may capture a bright pupil image within a single time slot assigned to a light source corresponding to the camera, and the other cameras may capture a dark pupil image.

For example, when the first light source is used as a coaxial light source, a camera may capture a bright pupil image within a time slot in which the first light source emits light. In this example, cameras corresponding to the second light source and the third light source may capture a dark pupil image. In the dark pupil image, at least one glint may be formed by reflecting light emitted by a light source from a cornea of a user, and position information of a plurality of corneal glints may be acquired by dark pupil images of consecutive multi-frames. In this example, when a camera has a high image collection speed, a position of a pupil may remain unchanged in the single period T.

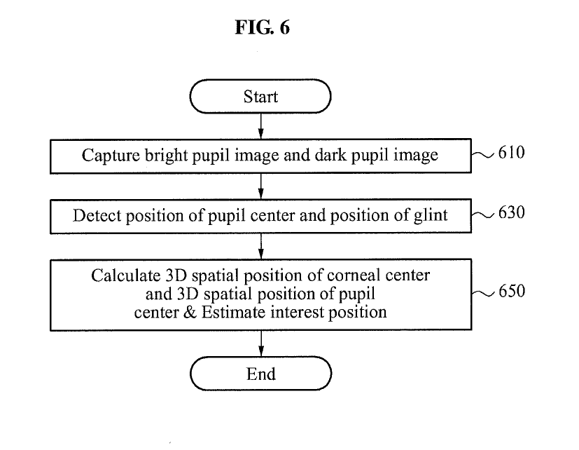

FIG. 6 illustrates a flowchart of a method of tracking a gaze according to example embodiments.

Referring to FIG. 6, in operation 610, a gaze tracking apparatus according to example embodiments may capture a bright pupil image and a dark pupil image of a user, using a camera array. The camera array may include a plurality of cameras, and a plurality of light sources corresponding to the plurality of cameras.

In operation 610, the gaze tracking apparatus may capture a bright pupil image using light emitted from a coaxial light source corresponding to a camera, and may capture a dark pupil image by the other cameras corresponding to off-axis light sources.

In operation 630, the gaze tracking apparatus may detect a position of a pupil center of each of eyes of the user and a position of a glint caused by reflection of the light sources, from the bright pupil image and the dark pupil image that are captured in operation 610.

In operation 630, the gaze tracking apparatus may detect the position of the pupil center from the bright pupil image, and may detect the position of the glint from the dark pupil image.

A scheme by which the gaze tracking apparatus detects the position of the pupil center will be further described with reference to FIGS. 7 and 8, and a scheme of the gaze tracking apparatus detects the position of the glint will be further described with reference to FIGS. 9 and 10.

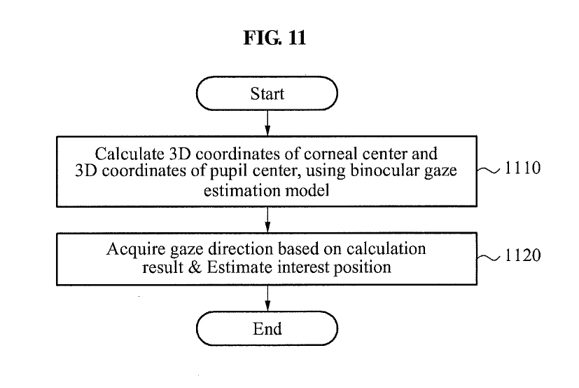

In operation 650, the gaze tracking apparatus may calculate a 3D spatial position of a corneal center of each of the eyes, and a 3D spatial position of the pupil center, based on the position of the pupil center and the position of the glint that are detected in operation 630, and may estimate an interest position of the eyes based on the calculated 3D spatial position of the corneal center of each of the eyes and the calculated 3D spatial position of the pupil center. A scheme by which the gaze tracking apparatus estimates the interest position will be further described with reference to FIG. 11.

FIG. 7 illustrates a flowchart of an example of a method of detecting a position of a pupil center from a bright pupil image according to example embodiments.

Referring to FIG. 7, in operation 710, a detector of a gaze tracking apparatus according to example embodiments may divide a pupil area in a bright pupil image, based on grayscale information of an eye area included in the bright pupil image. The pupil area in the bright pupil image may be brightened by a coaxial light source and accordingly, a grayscale of the pupil area may be higher than a grayscale of a neighboring area. The detector may divide the pupil area, based on the grayscale of the pupil area that is higher than the grayscale of the neighboring area. The pupil area may be divided using an image division method, for example, an area growth method, a threshold division method, and the like.

In operation 730, the detector may perform ellipse fitting on an outline of the pupil area divided in operation 710. The ellipse fitting has been known to those skilled in the art and accordingly, further description thereof is omitted here.

In operation 750, the detector may determine a center of an ellipse fitted in operation 730 as a pupil center of a user, and may detect a position of the pupil center.

FIG. 8 illustrates a flowchart of another example of a scheme of detecting a position of a pupil center from a bright pupil image according to example embodiments.

FIG. 8 illustrates a scheme of detecting a position of a pupil center of a user from a bright pupil image 801, and examples of a pupil image changed by performing operations 810 through 850.

Referring to FIG. 8, in operation 810, a detector of a gaze tracking apparatus according to example embodiments may binarize a bright pupil image 801 to obtain a binarized image 802, and may perform morphological filtering on the binarized image 802. The bright pupil image 801 may include images of two eyes within a viewing angle of a camera.

In operation 820, the detector may extract a central point by line by line scanning the binarized image 802 on which the morphological filtering is performed in operation 810, using a B-W-B pattern. The central point extracted in operation 820 may refer to a central point of a white part in the binarized image 802. For example, when the binarized image 802 includes two white parts, two central points may be extracted, as shown in an image 803.

The B-W-B pattern may refer to a pattern in which a black part, a white part, and a black part are sequentially arranged. In operation 820, to extract a central point, a white-black-white (W-B-W) pattern, or a white-gray-black-gray-white (W-G-B-G-W) pattern may be used, in addition to the B-W-B pattern.

In operation 830, the detector may detect a pupil area, displayed in the form of a circle in an image 804, based on central points extracted in operation 820.

In operation 840, the detector may remove outliers by random sample consensus (RANSAC) line fitting. The outliers may refer to abnormal values outside a distribution, and may correspond to white areas other than the pupil area in the image 804.

In operation 850, the detector may perform ellipse fitting on the image from which the outliers haven been removed in operation 840. The detector may determine, as the pupil center of the user, a center of an ellipse fitted in operation 850 as shown in an image 805, and may detect a position of the pupil center, as shown in an image 806.

FIG. 9 illustrates a flowchart of a scheme of detecting a position of a glint from a dark pupil image according to example embodiments.

Referring to FIG. 9, in operation 910, a detector of a gaze tracking apparatus according to example embodiments may search for a circular glint closest to a position of a pupil center of a user from among glints that are adjacent to each other and that are similar in size, in a dark pupil image.

In operation 920, the detector may determine a glint that is found in operation 910 as a corneal glint, and may detect a position of the corneal glint.

FIG. 10 illustrates a diagram of an example of detecting a position of a glint from a dark pupil image according to example embodiments.

Referring to FIG. 10, a dark pupil image 1030 may be captured by a plurality of cameras.

A light source controller of a gaze tracking apparatus according to example embodiments may allow a plurality of light sources to sequentially emit light, and may control a detector to detect, from the dark pupil image 1030, a position of a glint that appears in a cornea of an eye of a user due to reflection of the light sources.

In the dark pupil image 1030, glints 1035 caused by the reflection of the light sources may be significantly different in grayscale from the other areas. For example, the glints 1035 may be displayed more brightly than the other areas. Similarly to the glints 1035 appearing in a cornea, a glint may appear in a sclera of an eye, and accordingly a corneal glint and a scleral glint may need to be distinguished from each other.

A corneal glint may satisfy conditions described below, in contrast with a scleral glint.

Corneal glints may be similar to each other in size, and may be located adjacent to each other in positions near to a pupil center of a user. Additionally, corneal glints may have regular shapes similar to small circles.

The detector may detect a position of a glint based on a corneal glint satisfying the above-described conditions among glints detected from the dark pupil image 1030.

FIG. 11 illustrates a flowchart of a scheme of estimating an interest position of eyes according to example embodiments.

Referring to FIG. 11, in operation 1110, an estimator of a gaze tracking apparatus according to example embodiments may calculate 3D coordinates of a corneal center of each of the eyes, and 3D coordinates of a pupil center of each of the eyes, using a binocular gaze estimation model. The binocular gaze estimation model may be formed based on a position of the pupil center and a position of a glint that are detected by a detector of the gaze tracking apparatus.

In operation 1120, the estimator may acquire a gaze direction of the eyes, based on a calculation result of operation 1110, and may estimate an interest position of the eyes.

A scheme by which the estimator estimates the interest position using the binocular gaze estimation model will be further described with reference to FIG. 12.

FIG. 12 illustrates a diagram of a binocular gaze estimation model according to example embodiments.

The binocular gaze estimation model of FIG. 12 may be formed based on a position of a pupil center and a position of glint that are detected by a detector of a gaze tracking apparatus according to example embodiments. In FIG. 12, p₁, c₁, qᵢⱼ₋₁, and rⱼ₋₁ denote a pupil center, a corneal center, a light reflection point, and a refraction point of a left eye, respectively, and p₂, c₂, qᵢⱼ₋₂, and rᵢⱼ₋₂ denote a pupil center, a corneal center, a light reflection point, and a refraction point of a right eye, respectively. Additionally, oⱼ denotes a nodal point of a lens of a camera j, vⱼ₋₁ and uᵢⱼ₋₁ denote a position of a pupil center, and a position of a glint of the right eye, respectively, and vⱼ₋₂ and uᵢⱼ₋₂ denote a position of a pupil center, and a position of a glint of the left eye, respectively.

The gaze tracking apparatus may estimate an interest position of eyes, using a binocular gaze estimation model. For example, the gaze tracking apparatus may determine or estimate the interest position, by obtaining solutions of Equations 1 through 11 that are shown below. Equations 1 through 11 may be applied to each of a left eye and a right eye.

In the binocular gaze estimation model of FIG. 12, modeling may be performed on a ray that comes from a light reflection point qᵢⱼ of a cornea, that passes through the nodal point and that intersects an image plane at a position uᵢⱼ of a glint captured by the camera j.

Additionally, modeling may be performed on a ray that comes from a pupil center p, that is refracted at a refraction point r of a corneal surface, that passes through the nodal point oⱼ, and that intersects the image plane at a position vⱼ of a pupil center captured by the camera j.

A visual axis of the left eye, and a visual axis of the right eye may intersect at a fixation point R.

A condition that a ray, coming from a light reflection point qᵢⱼ of a cornea and passing through the nodal point intersects the image plane at a position uᵢⱼ of a glint in a dark pupil image captured by the camera j may be expressed as shown in Equation 1 below.

qᵢⱼ=oⱼ+k_{q,ij}(oⱼ−uᵢⱼ) for some k_{q,ij} [Equation 1]

In Equation 1, qᵢⱼ denotes a light reflection point of a cornea, and oⱼ denotes a nodal point of a lens of the camera j, as described above. Additionally, uᵢⱼ denotes a position of a glint in a dark pupil image, and k_{q,ij} denotes a slope of a straight line connecting the light reflection point qᵢⱼ and the position uᵢⱼ of the glint.

A corneal surface may be modeled as a convex spherical surface with a radius r_{c}. The light reflection point qᵢⱼ may be expressed as shown in Equation 2.

∥qᵢⱼ−c∥=r_{c} [Equation 2]

In Equation 2, c denotes a corneal center, and r_{c} denotes a radius constant of a spherical surface of a cornea.

Additionally, a law of reflection may satisfy the following two conditions:

An incident ray, a reflected ray, and a normal ray at a reflection point may be required to be coplanar. An angle of incidence may be required to be equal to an angle of reflection.

The two conditions may be expressed as shown Equations 3 and 4 below.

(lᵢ−oⱼ)×(qᵢⱼ−oⱼ)·(c−oⱼ)=0 [Equation 3]

In Equation 3, lᵢ denotes a position of an off-axis light source.

(lᵢ−qᵢⱼ)·(qᵢⱼ−c)*∥oⱼ−qᵢⱼ∥=(oⱼ−qᵢⱼ)×(qᵢⱼ−c)*∥lᵢ−qᵢⱼ∥ [Equation 4]

In Equation 4, × denotes a cross product of a vector, · denotes a dot product of a vector, and * denotes multiplication.

A ray that comes from the pupil center p, and a refracted ray that passes through the nodal point oⱼ and intersects the image plane at the position vⱼ of the pupil center in a bright pupil image may be taken into consideration.

A condition that a ray, coming from a refraction point rⱼ of a corneal surface and passing through the nodal point oⱼ, intersects the image plane at the position vⱼ of the pupil center may be expressed as shown in Equation 5 below.

rⱼ=oⱼ+k_{r,j}(oⱼ−vⱼ) [Equation 5]

In Equation 5, rⱼ denotes a refraction point of a cornea, vⱼ denotes a position of a pupil center in a bright pupil image, and k_{r,j} denotes a slope of a straight line connecting the refraction point rⱼ and the position vⱼ of the pupil center.

A condition that the refraction point rⱼ is on a corneal surface may be expressed as shown in Equation 6 below.

∥rⱼ−c∥=r_{c} [Equation 6]

Accordingly, a law of refraction may satisfy the following two conditions:

An incident ray, a refracted ray, and a normal ray at a refraction point may be required to be coplanar. Additionally, an angle of incidence, and an angle of refraction may be required to satisfy Snell's law.

A condition that rays lie in the same plane at a refraction point may be expressed as shown in Equation 7 below. A condition that an angle of incidence, and an angle of refraction satisfy Snell's law may be expressed as shown in Equation 8 below.

(rⱼ−oⱼ)×(c−oⱼ)·(p−oⱼ)=0 [Equation 7]

In Equation 7, p denotes a pupil center.

n₁*∥(rⱼ−c)×(p−rⱼ)∥*∥(oⱼ−rⱼ∥=n₂*∥(rⱼ−c)×(oⱼ−rⱼ)∥*∥p−rⱼ∥ [Equation 8]

In Equation 8, n₁ denotes a refraction coefficient between an aqueous humor and a cornea, and n₂ denotes a refraction coefficient between air and a cornea.

The aqueous humor refers to transparent fluid that fully fills an anterior chamber between a cornea and an iris, and a posterior chamber between the iris and an eye lens.

A distance K between a pupil center p and a center c of a corneal curvature may be expressed by ∥p−c∥=K.

An optical axis of a left eye and an optical axis of a right eye may be respectively expressed as shown in Equations 9 and 10 below.

R=c₁+k₁(p₁−c₁) [Equation 9]

In Equation 9, R denotes a gaze interest position of eyes, c₁ denotes a corneal center of the left eye, p₁ denotes a pupil center of the left eye, and k₁ denotes a slope of a gaze optical axis of the left eye.

R=c₂+k₂(p₂−c₂) [Equation 10]

In Equation 10, c₂ denotes a corneal center of the right eye, p₂ denotes a pupil center of the right eye, and k₂ denotes a slope of a gaze optical axis of the right eye.

The two optical axes may intersect at the fixation point R of FIG. 12 and accordingly, Equations 9 and 10 may be summarized as shown in Equation 11 below.

c₁+k₁(p₁−c₁)=c₂+k₂(p₂−c₂) [Equation 11]

Solutions of Equations 1 through 8 for the left eye and right eye may be obtained by three constraint conditions expressed by Equations 9 through 11.

A total of 16 solutions of Equations 1 through 8 for the left eye and right eye may be obtained by the three constraint conditions expressed by Equations 9 through 11. When an equation is actually calculated, n₁ and n₂ may be omitted.

For example, when “N” light sources are installed in a camera array, eight equations, that is, Equations 1 through 8 may be established for each of the “N” light sources in each of the left eye and right eye. Accordingly, a total of “16×N” solutions may be obtained by applying the three constraint conditions to the left eye and right eye.

Accordingly, a gaze tracking apparatus according to example embodiments may acquire 3D coordinates of a pupil center of eyes, and 3D coordinates of a corneal center of the eyes, and may determine an interest position of the eyes.

FIG. 13 illustrates a flowchart of a scheme of correcting an estimated interest position according to example embodiments.

Referring to FIG. 13, when an interest position of eyes is estimated, a gaze tracking apparatus according to example embodiments may determine a position of each of a plurality of points that are already estimated, and may correct the interest position.

In operation 1310, the gaze tracking apparatus may set, in advance, a plurality of target points that are already estimated on a screen at which a user gazes, and may determine a position of each of the target points by performing operations 610 through 650 of FIG. 6.

In operation 1320, the gaze tracking apparatus may calculate an error between an actual position of each of the target points and the position of each of the target points that is determined in operation 1310.

In operation 1330, the gaze tracking apparatus may calculate a weight based on a distance between an interest position estimated through operations 610 through 650 and the position of each of the target points determined in operation 1310.

In operation 1340, the gaze tracking apparatus may correct the estimated interest position, using an error correction model that is based on the error calculated in operation 1320 and the weight calculated in operation 1330.

The above-described processes may be expressed as shown in Equations 12 through 15 below.

The gaze tracking apparatus may correct the estimated interest position, using Equation 12 below.

$${P}_{processed} = {P}_{computed} + {\sum }_{i = 1 , … , M} {w}_{i} \times {e}_{i} \qquad [ Equation 12 ]$$

In Equation 12, P_{processed} denotes a corrected interest position of eyes, and P_{computed} denotes an interest position of eyes that is estimated through operations 610 through 650, by an estimator of the gaze tracking apparatus.

Additionally, M denotes the number of target points that are already estimated, wᵢ denotes a weight, and eᵢ denotes an error between an actual position of a target point and a position of a target point that is estimated through operations 610 through 650 by the estimator.

The error eᵢ may be expressed as shown in Equation 13 below.

eᵢ=(sᵢ−pᵢ) [Equation 13]

In Equation 13, Sᵢ denotes an actual position of a target point that is already estimated, and Pᵢ denotes a position of a target point that is estimated through operations 610 through 650 by the estimator.

A distance dᵢ between an interest position estimated through operations 610 through 650 and a position of an already estimated target point may be expressed as shown in Equation 14 below.

d₁=∥P_{computed}−pᵢ∥ [Equation 14]

The weight wᵢ may be obtained using Equation 15 below.

$${w}_{i} = \{ \begin{matrix}\frac{1}{{d}_{i} \times {\sum }_{i = 1 , … , M} \frac{1}{{d}_{i}}} , & {d}_{i} > 0 \\ 1 , & {d}_{i} = 0 \\ 0 , & {d}_{i} > 0 , {d}_{i} - {d}_{j} = 0\end{matrix} \qquad [ Equation 15 ]$$

The units described herein may be implemented using hardware components and software components. For example, the hardware components may include microphones, amplifiers, band-pass filters, audio to digital convertors, and processing devices. A processing device may be implemented using one or more general-purpose or special purpose computers, such as, for example, a processor, a controller and an arithmetic logic unit, a digital signal processor, a microcomputer, a field programmable array, a programmable logic unit, a microprocessor or any other device capable of responding to and executing instructions in a defined manner. The processing device may run an operating system (OS) and one or more software applications that run on the OS. The processing device also may access, store, manipulate, process, and create data in response to execution of the software. For purpose of simplicity, the description of a processing device is used as singular; however, one skilled in the art will appreciated that a processing device may include multiple processing elements and multiple types of processing elements. For example, a processing device may include multiple processors or a processor and a controller. In addition, different processing configurations are possible, such a parallel processors.

The software may include a computer program, a piece of code, an instruction, or some combination thereof, to independently or collectively instruct or configure the processing device to operate as desired. Software and data may be embodied permanently or temporarily in any type of machine, component, physical or virtual equipment, computer storage medium or device, or in a propagated signal wave capable of providing instructions or data to or being interpreted by the processing device. The software also may be distributed over network coupled computer systems so that the software is stored and executed in a distributed fashion. The software and data may be stored by one or more non-transitory computer readable recording mediums. The non-transitory computer readable recording medium may include any data storage device that can store data which can be thereafter read by a computer system or processing device. Examples of the non-transitory computer readable recording medium include read-only memory (ROM), random-access memory (RAM), CD-ROMs, magnetic tapes, floppy disks, optical data storage devices. Also, functional programs, codes, and code segments that accomplish the examples disclosed herein can be easily construed by programmers skilled in the art to which the examples pertain based on and using the flow diagrams and block diagrams of the figures and their corresponding descriptions as provided herein.

As a non-exhaustive illustration only, a terminal or device described herein may refer to mobile devices such as a cellular phone, a personal digital assistant (PDA), a digital camera, a portable game console, and an MP3 player, a portable/personal multimedia player (PMP), a handheld e-book, a portable laptop PC, a global positioning system (GPS) navigation, a tablet, a sensor, and devices such as a desktop PC, a high definition television (HDTV), an optical disc player, a setup box, a home appliance, and the like that are capable of wireless communication or network communication consistent with that which is disclosed herein.

A number of examples have been described above. Nevertheless, it should be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

Although a few embodiments have been shown and described, it would be appreciated by those skilled in the art that changes may be made in these embodiments without departing from the principles and spirit of the disclosure, the scope of which is defined in the claims and their equivalents.

What is claimed is:

1. An apparatus for tracking a gaze, the apparatus comprising:
a camera array comprising a plurality of cameras, and a plurality of light sources for the plurality of cameras;
a light source controller to control the plurality of light sources so that the plurality of cameras capture a bright pupil image and a dark pupil image of a user;
a detector to detect a position of a pupil center of the user, and a position of a glint caused by reflection of the plurality of light sources from the captured bright pupil image and the captured dark pupil image; and
an estimator to estimate an interest position of eyes of the user by tracking a gaze direction of the eyes, based on the detected position of the pupil center and the detected position of the glint.

2. The apparatus of claim 1, wherein a camera from among the plurality of cameras in the camera array captures a bright pupil image of the user using light emitted from a coaxial light source corresponding to the camera, and captures a dark pupil image of the user using light emitted from an off-axis light source that does not correspond to the camera.

3. The apparatus of claim 1, wherein the light source controller allows the plurality of light sources to sequentially emit light.

4. The apparatus of claim 1, wherein the detector detects the position of the pupil center from the captured bright pupil image, and detects the position of the glint from the captured dark pupil image.

5. The apparatus of claim 4, wherein the detector detects the position of the pupil center based on grayscale information of an eye area in the bright pupil image.

6. The apparatus of claim 5, wherein the detector divides a pupil area in the bright pupil image based on the grayscale information, performs ellipse fitting on an outline of the divided pupil area, determines a center of a fitted ellipse as the pupil center, and detects the position of the pupil center.

7. The apparatus of claim 4, wherein the detector detects the position of the glint from the dark pupil image, based on a corneal glint.

8. The apparatus of claim 7, wherein the detector locating a circular glint closest to the position of the pupil center from among glints that are adjacent to each other and that are similar in size, in the dark pupil image, determines the located glint as the corneal glint, and detects the position of the glint.

9. The apparatus of claim 1, wherein the estimator calculates a three-dimensional (3D) spatial position of a corneal center of each of the eyes, and a 3D spatial position of the pupil center, based on the detected position of the pupil center and the detected position of the glint, and estimates the interest position based on a calculation result.

10. The apparatus of claim 1, wherein the estimator calculates three-dimensional (3D) coordinates of a corneal center of each of the eyes, and 3D coordinates of the pupil center, using a binocular gaze estimation model that is based on the detected position of the pupil center and the detected position of the glint, acquires the gaze direction based on a calculation result, and estimates the interest position.

11. The apparatus of claim 10, wherein the estimator acquires a gaze direction of each of the eyes in an optical axis of a gaze connecting the pupil center and the corneal center, based on the calculation result, and estimates the interest position.

12. The apparatus of claim 1, further comprising:
a corrector to correct the estimated interest position, using a plurality of target points that are estimated in advance in a surface at which the user gazes.

13. The apparatus of claim 12, wherein the detector determines a position of each of the plurality of target points, and
wherein the corrector calculates an error between an actual position of each of the plurality of target points and the determined position, and corrects the estimated interest position, using the error and a weight that is based on a distance between the interest position and the determined position.

14. A method for tracking a gaze, the method comprising:
capturing a bright pupil image and a dark pupil image of a user, using a camera array, the camera array comprising a plurality of cameras, and a plurality of light sources corresponding to the plurality of cameras;
detecting a position of a pupil center of the user, and a position of a glint caused by reflection of the plurality of light sources from the captured bright pupil image and the captured dark pupil image; and
calculating a three-dimensional (3D) spatial position of a corneal center of each of eyes of the user, and a 3D spatial position of the pupil center, based on the detected position of the pupil center and the detected position of the glint, respectively, and estimating an interest position of the eyes based on a calculation result.

15. The method of claim 14, wherein the capturing comprises:
capturing, by a camera from among the plurality of cameras in the camera array, a bright pupil image of the user using light emitted from a coaxial light source corresponding to the camera; and
capturing a dark pupil image of the user using light emitted from an off-axis light source that does not correspond to the camera.

16. The method of claim 14, wherein the detecting comprises:
dividing a pupil area in the bright pupil image, based on grayscale information of an eye area in the bright pupil image;
performing ellipse fitting on an outline of the divided pupil area; and
determining a center of a fitted ellipse as the pupil center, and detecting the position of the determined pupil center.

17. The method of claim 14, wherein the detecting comprises:
locating a circular glint closest to the position of the pupil center from among glints that are adjacent to each other and that are similar in size, in the dark pupil image; and
determining the located glint as a corneal glint, and detecting the position of the glint.

18. The method of claim 14, wherein the estimating comprises:
calculating 3D coordinates of a corneal center of each of the eyes, and 3D coordinates of the pupil center, using a binocular gaze estimation model that is based on the detected position of the pupil center and the detected position of the glint; and
acquiring a gaze direction of the eyes based on a calculation result, and estimating the interest position.

19. The method of claim 14, further comprising:
determining a position of each of a plurality of target points that are estimated in advance in a surface at which the user gazes;
calculating an error between an actual position of each of the plurality of target points and the determined position;
calculating a weight based on a distance between the interest position and the determined position; and
correcting the estimated interest position, using an error correction model that is based on the error and the weight.

20. A non-transitory computer readable recording medium storing a program to cause a computer to implement the method of claim 14.

21. The apparatus of claim 1, wherein at least one camera of the plurality of cameras and at least one light source of the plurality of light sources are shaped in concentric circles.

22. The apparatus of claim 1, wherein at least one light source of the plurality of light sources is installed as a coaxial light source about at least one camera of the plurality of cameras.

23. The apparatus of claim 1, wherein the light source controller controls the plurality of light sources to emit light at different time periods so that the plurality of cameras capture each of the bright pupil image and the dark pupil image of the user in the different time periods.
